(19) United States
(12) Patent Application Publication
(10) Pub. No.: US 2026/0335854 A1
(43) Pub. Date: Oct. 29, 2026

(54) SYSTEMS AND PROCESSES FOR TEMPERATURE CONTROL IN FLUIDIZED CATALYTIC CRACKING

(71) Applicants: T.EN PROCESS TECHNOLOGY INC., Houston, TX (US); SAUDI ARABIAN OIL COMPANY, Dhahran (SA); IFP ENERGIES NOUVELLES, Rueil-Mal maison Cedex (FR); AXENS, Rueil-Malmaison (FR)

(72) Inventors: Eusebius GBORDZOE, Houston, TX (US); Kenneth KRUG, Houston, TX (US); Abdul Rahman AKHRAS, Dhahran (SA); Jean-Francois LE COZ, Rueil-Malmaison (FR); Thibault JACQUEMIN, Rueil-Malmaison (FR); Jan VERSTRAETE, Solaize (FR)

(21) Appl. No.: 19/107,320

(22) PCT Filed: Aug. 31, 2023
(86) PCT No.: PCT/US2023/031713

§ 371 Date: Feb. 27, 2025

Related U.S. Application Data
(60) Provisional application No. 63/374,242, filed on Sep. 1, 2022.

(51) Int. Cl. B01J 8/26; B01J 8/18; C10G 11/18; C10G 51/06

(52) U.S. Cl. CPC B01J 8/26; B01J 8/1854; C10G 11/182; C10G 51/06; B01J 2208/00504

(57) ABSTRACT

A fluidized catalytic cracking (“FCC”) system includes a catalyst regenerator configured and adapted to regenerate a spent catalyst feed to produce a regenerated catalyst, a reactor downstream from an outlet of the catalyst regenerator to receive regenerated catalyst therefrom and a spent catalyst riser between an outlet of the reactor and an inlet of the regenerator. The spent catalyst riser includes a torch oil injection nozzle configured and adapted to provide heat to the catalyst regenerator. A process for controlling catalyst temperature in an FCC system includes regenerating a spent catalyst feed in a catalyst regenerator to produce a regenerated catalyst feed, withdrawing at least a portion of the regenerated catalyst feed to a reactor, receiving a spent catalyst from the reactor in a spent catalyst riser, and heating the spent catalyst in the spent catalyst riser with a torch oil injection nozzle. In embodiments, the reactor is a downer.

### CROSS-REFERENCE TO RELATED APPLICATIONS

The subject application claims the benefit of priority to U.S. Provisional Patent Application No. 63/374,242, filed Sep. 1, 2022, the disclosure of which is incorporated herein by reference in its entirety.

### BACKGROUND OF THE INVENTION

### 1. Field of the Invention

The present disclosure relates to fluidized catalytic cracking systems and processes and more particularly to downer fluid catalytic cracking systems and processes.

### 2. Description of Related Art

Fluidized catalytic cracking (“FCC”) processes are widely used for the conversion of hydrocarbon feed streams, such as vacuum gas oils and other relatively heavy oils, into lighter and more valuable hydrocarbon products. The basic components of a downer FCC system include at least one reactor, a spent catalyst riser, and a catalyst regenerator. In some cases, catalyst coolers are installed on the catalyst regenerator to control regenerator temperature within reasonable limits when processing heavy feedstocks.

Torch oil is used for preheating regenerator and catalyst during FCC start-up. This is a normal way for starting up FCC units. The regenerator, after loading with catalyst is preheated by direct-fired air preheater. The flue gas from the air preheater, at temperatures up to 1100-1200 °F is passed through the fluidized catalyst bed of the regenerator. After the catalyst bed attains about 700-800 °F, supplemental fuel, typically in the form of feed or light cycle oil (LCO), is directly injected into the hot catalyst. Because of the temperature, the supplemental fuel automatically combusts. The supplemental fuel is commonly referred to as torch oil. The heat released from the torch oil combustion heats the catalyst bed further to about 1300 °F prior to starting catalyst circulation. When the hydrocarbon feedstock does not make sufficient coke in the riser to satisfy the heat duty required for cracking the feed, torch oil can generally be burnt continuously in the regenerator to supply the additional heat required.

Several patents describe the use of torch oil in the regenerator. In U.S. Pat. No. 3,909,392, the localized combustion of torch oil results in high catalyst particle temperature with severe catalyst de-activation through catalyst sintering and loss of active sites on the catalyst. Loss of catalyst activity requires increase in the catalyst make-up rate thus, increasing operating cost. In International Publication No. WO 2016/200565, although the torch oil injection is staged in this high efficiency regenerator, the net effect is less severe than the drawbacks discussed above. In International Publication No. WO 01/74972, the flow regime in the spent catalyst lift line is not ideal for fuel combustion because of the limited degree of backmixing, which permits potential for catalyst deactivation even though torch oil injection is staged to limit the heat release per injection location. In International Publication No. WO 01/7497, the effects of direct torch oil into the regenerator include potential refractory damage, uneven catalyst flow, and slug flow from over injection of torch oil.

The conventional techniques have been considered satisfactory for their intended purpose. However, there is an ever present need for improved catalyst heating. This disclosure provides a solution for this need.

### SUMMARY OF THE INVENTION

A fluidized catalytic cracking (“FCC”) system includes a catalyst regenerator configured and adapted to regenerate a spent catalyst feed to produce a regenerated catalyst. The system includes a reactor downstream from an outlet of the catalyst regenerator to receive regenerated catalyst therefrom. The system includes a spent catalyst riser between an outlet of the reactor and an inlet of the regenerator. The spent catalyst riser includes a torch oil injection nozzle configured and adapted to provide heat to the catalyst regenerator.

One or more embodiments include the system of any previous paragraph, and wherein a spent catalyst riser can include a mixing area downstream from an outlet of the reactor and upstream from an inlet of the catalyst regenerator.

One or more embodiments include the system of any previous paragraph, and wherein the torch oil injection nozzle can be positioned to inject torch oil into the mixing area.

One or more embodiments include the system of any previous paragraph, and wherein the spent catalyst riser can include an air injector downstream from the torch oil injection nozzle.

One or more embodiments include the system of any previous paragraph, and wherein the spent catalyst riser can include an air injector upstream from the torch oil injection nozzle.

One or more embodiments include the system of any previous paragraph, and wherein the spent catalyst riser can include at least one air injector upstream from the torch oil injection nozzle and at least one air injector downstream from the torch oil injection nozzle.

In accordance with another aspect, a process for controlling catalyst temperature in an FCC system includes regenerating a spent catalyst feed in a catalyst regenerator to produce a regenerated catalyst feed, withdrawing at least a portion of the regenerated catalyst feed to a to a reactor, receiving a spent catalyst from the reactor in a spent catalyst riser, and heating the spent catalyst in the spent catalyst riser with a torch oil injection nozzle.

One or more embodiments include the process of any previous paragraph, and wherein the reactor can be downstream from an outlet of the catalyst regenerator to receive regenerated catalyst therefrom.

One or more embodiments include the process of any previous paragraph, and wherein the spent catalyst riser can be positioned between an outlet of the reactor and an inlet of the catalyst regenerator.

One or more embodiments include the process of any previous paragraph, and wherein the spent catalyst riser can include a mixing area downstream from an outlet of the reactor and upstream from an inlet of the catalyst regenerator.

One or more embodiments include the process of any previous paragraph, and wherein heating the spent catalyst can include injecting torch oil into the mixing area with the torch oil injection nozzle.

One or more embodiments include the process of any previous paragraph, and wherein the process can include injecting air downstream from the torch oil injection nozzle with an air injector.

One or more embodiments include the process of any previous paragraph, and wherein the process can include injecting air upstream from the torch oil injection nozzle with an air injector.

One or more embodiments include the process of any previous paragraph, and wherein the process can include injecting air upstream from the torch oil injection nozzle with a first air injector and injecting air downstream from the torch oil injection nozzle with at least one second air injector.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic plan view of a FCC system having catalyst heating constructed in accordance with an embodiment of the present disclosure, showing the torch oil injection nozzle in the spent catalyst riser configured and adapted to provide heat to the catalyst regenerator; and

FIG. 2 is an enlarged schematic plan view of the FCC system of FIG. 1, showing the torch oil injection nozzle in the spent catalyst riser.

### DETAILED DESCRIPTION OF THE PREFERRED EMBODIMENTS

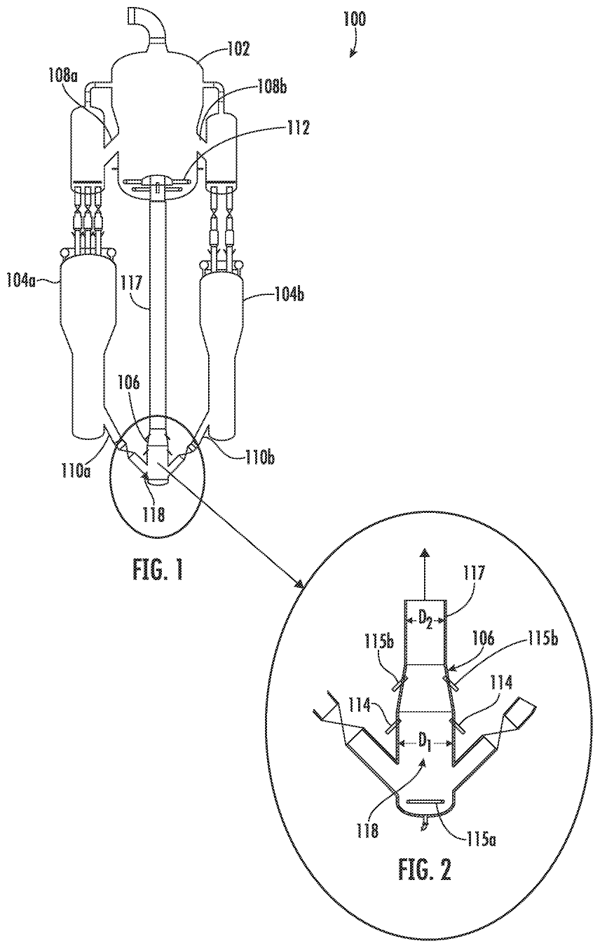

Reference will now be made to the drawings wherein like reference numerals identify similar structural features or aspects of the subject disclosure. For purposes of explanation and illustration, and not limitation, a schematic view of an exemplary embodiment of a fluidized catalytic cracking (“FCC”) system is shown in FIG. 1 and is designated generally by reference character 100. Other embodiments of the FCC system in accordance with the disclosure, or aspects thereof, are provided in FIG. 2 as will be described. The systems and methods described herein avoid direct injection of torch oil into the regenerator, thereby avoiding certain issues associated with traditional localized combustion of torch oil in the regenerator, such as high catalyst particle temperature with severe catalyst de-activation through catalyst sintering and loss of active sites on the catalyst.

As shown in FIG. 1, a FCC system 100 includes a catalyst regenerator 102 configured and adapted to regenerate a spent catalyst feed to produce a regenerated catalyst. System 100 includes light feed (LF) and heavy feed (HF) reactors 104a and 104b, respectively, downstream from respective outlets 108a and 108b of catalyst regenerator 102 to receive regenerated catalyst therefrom. System 100 includes a spent catalyst riser 106 between respective outlets 110a and 110b of reactors 104a and 104b and an inlet 112 of regenerator 102. Spent catalyst riser 106 includes a mixing area 118 downstream from outlets 110a and 110b of reactors 104a and 104b and upstream from an inlet 112 of catalyst regenerator 100. The spent catalyst from LF reactor 104a and that from HF reactor 104b are mixed together in mixing area 118 at the bottom of spent catalyst lift riser 106. The mixed catalyst from is conveyed using air into regenerator 102 where the coke deposited on the catalyst is burnt off.

Since a large portion of the hydrocarbon feed to the system shown in FIGS. 1-2 is light crude oil, the total amount of coke produced from the cracking reactions in the LF reactor 104a and HF reactor 104b is not sufficient to sustain the desired regenerator temperature required to burn off the coke from the catalyst and provide the heat required for the cracking process. A large quantity of torch oil is required to close the heat balance deficit. Injecting the required amount of torch oil into regenerator 102 would lead to drawbacks, e.g., high catalyst particle temperature with severe catalyst de-activation through catalyst sintering and loss of active sites on the catalyst, increased operating costs due to loss of catalyst activity, and catalyst attrition and refractory damage, among other things. Instead, the embodiment of FIGS. 1-2 includes mixing area 118 designed to properly mix the two spent catalyst streams and at the same time provide adequate turbulence for injection of the torch oil. Spent catalyst riser 106 includes torch oil injection nozzles 114 configured and adapted to provide heat to catalyst regenerator 102 via mixing area 118. This configuration reduces catalyst deactivation. Torch oil injection nozzles 114 inject supplemental fuel, e.g., torch oil, in the spent catalyst riser 106 to provide heat to maintain regeneration temperature. The torch oil droplets from torch oil nozzles 114 will contact the hot catalyst particles, deposit on them and vaporize or possibly crack. The vapors produced burn under sub-stoichiometric conditions since only about 40% of the total combustion air is supplied through spent catalyst riser 106. The vapors and combustion gases act to lift the catalyst into regenerator 102 where they are evenly distributed in the catalyst bed of regenerator 102. The turbulent mixing energy is achieved through a balance between the mixing zone 118 diameter D₁ to lift line 117 diameter D₂ and lift gas velocity. Air lift gas is staged and provided by air injectors 115a and 115b. An air injection distributor is provided as first injector 115a at the bottom of mixing area 118, and the rest is injected with air injector nozzles 115b just above torch oil injection nozzles 114 located at the top of mixing area 118. While first injector 115a is shown schematically as a cross-section of a ring-type distributor, those skilled in the art will readily appreciate that first injector 115a can be comprised of a single nozzle or multiple nozzles, and can be a ring type distributor or a showerhead type distributor.

As shown in FIGS. 1-2, torch oil injection nozzles 114 are positioned to inject torch oil into mixing area 118. Spent catalyst riser 106 includes air injectors 115a and 115b upstream and downstream from torch oil injection nozzles 114. Spent catalyst riser 106 includes at least one air injector 115a upstream from torch oil injection nozzles 114 and air injectors 115b downstream from torch oil injection nozzles 114. Heating with torch oil injection nozzles 114, prior to reaching the regenerator 102, allows catalyst from both LF and HF reactors 104a and 104b to be evenly coated with oil or coke before it enters regenerator 102. Any vapor formed from oil cracking or flashing on the catalyst surface aids in catalyst transport into regenerator 102. The air injectors 115a and 115b generate a very turbulent zone in spent catalyst riser 106 for injecting the torch oil into. This turbulent zone provides better mixing and heat transfer characteristics than a normal bubbling bed.

Additionally, by avoiding direct injection of torch oil into regenerator 102, the localized combustion of torch oil can also be avoided. Localized combustion of torch oil in certain traditional applications can result in high catalyst particle temperature with severe catalyst de-activation through catalyst sintering and loss of active sites on the catalyst. Loss of catalyst activity requires increase in the catalyst make-up rate thus, increasing operating cost. Injection of torch oil directly into regenerator 102 may also cause catalyst attrition and refractory damage. System 100 is more efficient than injecting torch oil into the stripper of the FCC unit or high severity FCCUs, or the like. Although this option would deposit coke/hydrocarbons uniformly on the catalyst as it travels through the stripper, approximate 40% of the torch oil is converted to coke. The rest vaporizes or cracks into vapor products that combines with the cracked vapors into the main fractionator. This loss of “efficiency” in transferring all the torch oil onto the catalyst results in higher torch oil flowrate to satisfy the heat balance.

A process for controlling catalyst temperature in an FCC system, e.g., system 100, includes regenerating a spent catalyst feed in a catalyst regenerator, e.g., catalyst regenerator 102, to produce a regenerated catalyst feed. The process includes withdrawing at least a portion of the regenerated catalyst feed to at least one reactor, e.g., reactors 104a and 104b. The process includes receiving spent catalyst from the reactors in a spent catalyst riser, e.g., spent catalyst riser 106. The process includes heating the spent catalyst in the spent catalyst riser with a torch oil injection nozzle, e.g., torch oil injection nozzles 114. The process includes injecting air upstream from the torch oil injection nozzle with a first air injector, e.g., air injector 115a, and injecting air downstream from the torch oil injection nozzle with second air injectors, e.g., air injectors 115b. The spent catalyst riser is positioned between an outlet of the reactor, e.g., outlets 110a and/or 110b, and an inlet, e.g. inlet 112, of the catalyst regenerator. Heating the spent catalyst includes injecting torch oil into the mixing area with the torch oil injection nozzle. In some embodiments, hot spots in regenerator 102 can be minimized due to continuous injection of such a large amount of torch oil.

The methods and systems of the present disclosure, as described above and shown in the drawings, provide for FCC systems designed to provide heat to a catalyst prior to reaching a catalyst regenerator with superior properties including reduced catalyst deactivation. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A fluidized catalytic cracking (“FCC”) system, the system comprising:
a catalyst regenerator configured and adapted to regenerate a spent catalyst feed to produce a regenerated catalyst;
a reactor downstream from an outlet of the catalyst regenerator to receive regenerated catalyst therefrom; and
a spent catalyst riser between an outlet of the reactor and an inlet of the regenerator, the spent catalyst riser including a torch oil injection nozzle configured and adapted to provide heat to the catalyst regenerator.

2. The system as recited in claim 1, wherein the spent catalyst riser includes a mixing area downstream from an outlet of the reactor and upstream from an inlet of the catalyst regenerator.

3. The system as recited in claim 1, wherein the torch oil injection nozzle is positioned to inject torch oil into the mixing area.

4. The system as recited in claim 1, wherein the spent catalyst riser includes an air injector downstream from the torch oil injection nozzle.

5. The system as recited in claim 1, wherein the spent catalyst riser includes an air injector upstream from the torch oil injection nozzle.

6. The system as recited in claim 1, wherein the spent catalyst riser includes at least one air injector upstream from the torch oil injection nozzle and at least one air injector downstream from the torch oil injection nozzle.

7. A process for controlling catalyst temperature in a fluidized catalytic cracking (“FCC”) system, the process comprising:
regenerating a spent catalyst feed in a catalyst regenerator to produce a regenerated catalyst feed;
withdrawing at least a portion of the regenerated catalyst feed to a to a reactor;
receiving a spent catalyst from the reactor in a spent catalyst riser; and
heating the spent catalyst in the spent catalyst riser with a torch oil injection nozzle.

8. The process as recited in claim 7, wherein the reactor is downstream from an outlet of the catalyst regenerator to receive regenerated catalyst therefrom.

9. The process as recited in claim 7, wherein the spent catalyst riser is positioned between an outlet of the reactor and an inlet of the catalyst regenerator.

10. The process as recited in claim 7, wherein the spent catalyst riser includes a mixing area downstream from an outlet of the reactor and upstream from an inlet of the catalyst regenerator.

11. The process as recited in claim 7, wherein heating the spent catalyst includes injecting torch oil into the mixing area with the torch oil injection nozzle.

12. The process as recited in claim 7, further comprising injecting air downstream from the torch oil injection nozzle with an air injector.

13. The process as recited in claim 7, further comprising injecting air upstream from the torch oil injection nozzle with an air injector.

14. The process as recited in claim 7, further comprising injecting air upstream from the torch oil injection nozzle with a first air injector and injecting air downstream from the torch oil injection nozzle with at least one second air injector.
